(19) United States
(12) Patent Application Publication
(10) Pub. No.: US 2025/0306825 A1
(43) Pub. Date: Oct. 2, 2025

(54) PRINTER AND CONTROL METHOD FOR A PRINTER

(71) Applicant: Toshiba Tec Kabushiki Kaisha, Tokyo (JP)

(72) Inventor: Hiroyuki INABA, Izunokuni Shizuoka (JP)

(21) Appl. No.: 18/977,057

(22) Filed: Dec. 11, 2024

(30) Foreign Application Priority Data
Mar. 27, 2024 (JP) 2024-050806

(51) Int. Cl. G06F 3/12; G06Q 20/20

(52) U.S. Cl. CPC G06F 3/1254; G06F 3/1217; G06F 3/122; G06F 3/1236; G06F 3/1257; G06F 3/126; G06F 3/1286; G06Q 20/209; G06F 3/1287

(57) ABSTRACT

In accordance with an embodiment, the printer receives a process request from an external device and executes a process requested by the process request. In addition, in a case where the number of processes requested by the process request and executed is two or more, the printer adjusts a predetermined parameter in accordance with execution of the processes.

### CROSS-REFERENCE TO RELATED APPLICATIONS

This application is based upon and claims the benefit of priority from the prior Japanese Patent Application No. 2024-50806, filed on Mar. 27, 2024, the entire contents of which are incorporated herein by reference.

### FIELD

An embodiment described here generally relates to a printer and a control method for a printer.

### BACKGROUND

Conventionally, some printers have a router function or access point function (hereinafter, also collectively referred as access point function) for connecting a communication terminal such as a portable terminal to a network.

Such a printer has a problem in that the performance of the printer's original print function lowers when the processing load of the access point function to connect the communication terminal to the network increases. In this regard, a technology for suppressing the performance decrease of the print function by executing more suitable control connection between the devices has been conventionally proposed.

However, in the conventional technology, the situation where a lower-priority process cannot be continued (hereinafter, also referred to as timeout) may occur because allocation of the printer's connection resources for connection control, i.e., process priorities are set.

### BRIEF DESCRIPTION OF THE DRAWINGS

FIG. 1 is a schematic diagram showing schematic configurations of a printer system according to an embodiment.

FIG. 2 is a block diagram showing an example of hardware configurations of a printer according to the embodiment.

FIG. 3 is a diagram showing an example of data configurations of a tethering table according to the embodiment.

FIG. 4 is a diagram showing an example of data configurations of a job table according to the embodiment.

FIG. 5 is a diagram showing an example of data configurations of a job attribute-identifying table according to the embodiment.

FIG. 6 is a diagram showing an example of data configurations of a parameter table according to the embodiment.

FIG. 7 is a block diagram showing an example of hardware configurations of an employee terminal according to the embodiment.

FIG. 8 is a block diagram showing an example of hardware configurations 4 POS terminal according to the embodiment.

FIG. 9 is a block diagram showing an example of function configurations of the printer, the employee terminal, and the POS terminal according to the embodiment.

FIG. 10 is a sequence diagram showing an example of control processing of the printer system according to the embodiment.

FIG. 11 is a flowchart showing an example of processing performed by a controller of the printer according to the embodiment.

### DETAILED DESCRIPTION

In accordance with an embodiment, a printer includes a storage device, a communication device, and a controller. The storage device stores a value related to setting of a predetermined parameter associated with execution of processes. The communication device is connected to be capable of communicating with an external device. The communication device communicates with the external device for the communication device to receive a process request of a process. The controller receives the process request from the external device via the communication device. The controller executes the requested process. In addition, the controller refers to, in a case where the number of processes requested by the process request and executed is two or more, a value related to setting of the parameter stored in the storage device and adjusts the parameter associated with the execution of the processes.

Hereinafter, an embodiment of a printer system 1 will be described with reference to the drawings. It should be noted that in the drawings, the same reference signs denote the same or similar portions. Moreover the present invention should not be limited by the following embodiment.

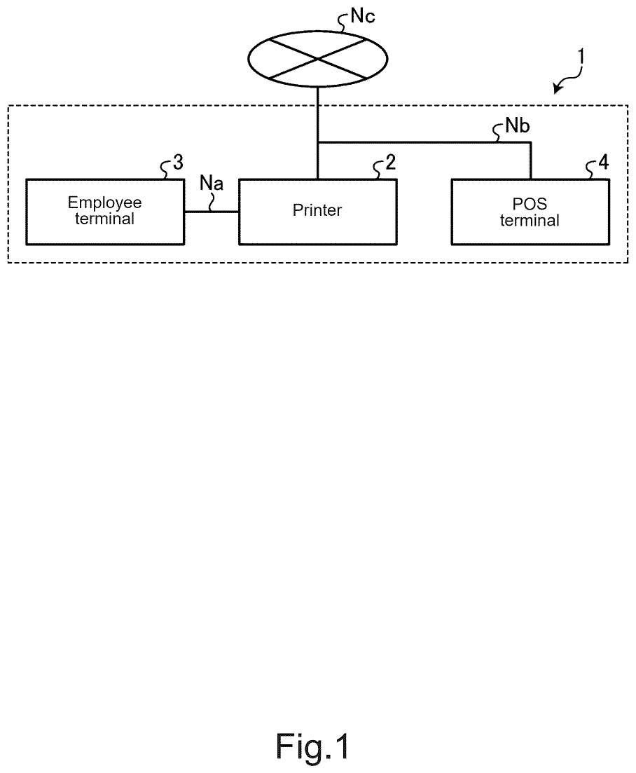

FIG. 1 is a schematic diagram showing schematic configurations of the printer system 1 according to an embodiment. As shown in FIG. 1, the printer system 1 includes a printer 2, an employee terminal 3, and a POS terminal 4.

The printer 2, the employee terminal 3, and the POS terminal 4 are provided at a store, for example. The printer 2 and the employee terminal 3 are installed in a checkout area of the store, for example.

The printer 2 and the employee terminal 3 are connected to be capable of communicating with each other via a connection line Na such as a universal serial bus (USB) cable. Moreover, the printer 2 and the POS terminal 4 are connected to be capable of communicating with each other via a network Nb such as a local area network (LAN). Moreover, the network Nb is connected to be capable of communicating with a network Nc such as the Internet via a communication device such as a hub or a router (not shown).

It should be noted that both the number of devices connected to the connection line Na and the number of devices connected to the network Nb are not limited to that in the example shown in the figure. Moreover, the printer 2 and the employee terminal 3 may be connected by wireless communication such as WiFi (registered trademark) or Bluetooth (registered trademark).

The printer 2 is a printer device such as a receipt printer. The printer 2 has a function of an access point for connecting the employee terminal 3 to the network Nc.

The printer 2 receives various process requests (hereinafter, also referred to as requests) from an external device. Specifically, the printer 2 receives from the employee terminal 3 a process request of a process (hereinafter, also referred to as tethering) of connecting to the network Nc via the printer 2. Moreover, the printer 2 receives process requests of processes (hereinafter, also referred to as jobs) executable by the printer 2 from for example the employee terminal 3 and the POS terminal 4.

Here, the tethering request is for example instruction information including a terminal ID that enables identification of the employee terminal 3 and instructing a controller 200 of the printer 2 to execute tethering. Moreover, the job requests are for example instruction information including terminal IDs of the employee terminal 3 and the POS terminal 4 and process types to be described later and instructing the controller 200 of the printer 2 to execute various processes.

Moreover, when the printer 2 receives a request from the employee terminal 3 or the POS terminal 4, the printer 2 executes a process instructed by the request. For example, when the printer 2 receives a tethering request from the employee terminal 3, the printer 2 executes tethering with the employee terminal 3, thereby allowing connection of the employee terminal 3 to the network Nc via the printer 2. Moreover, when the printer 2 receives a job request from the employee terminal 3 or the POS terminal 4, the printer 2 executes a job requested by the received job request.

Here, a typical job request sent from the employee terminal 3 or the POS terminal 4 is for example a print process (print job) using a print device 210 of the printer 2. It should be noted that the tethering and the job(s) may be executed by the controller 200 of the printer 2 in parallel.

Moreover, in a case of executing two or more processes in parallel, the printer 2 changes information associated with execution of the processes. Specifically, in a case of executing two or more processes in parallel, the printer 2 obtains the number of running processes. Then, the printer 2 changes a parameter associated with the execution of the processes in accordance with the number of running processes.

The employee terminal 3 is a terminal device such as a tablet-type computer that is used by the employee at the store, for example. The employee terminal 3 sends various requests to the printer 2. Specifically, the employee terminal 3 sends a tethering request to the printer 2.

The POS terminal 4 is a product sales data processing device that executes a product sales data process of products sold at the store. For example, the POS terminal 4 executes a registration process of registering products purchased by a customer or a settlement process according to settlement of products registered in the registration process. Moreover, the POS terminal 4 sends a request to the printer 2. Specifically, the POS terminal 4 sends a job request to the printer 2. For example, the POS terminal 4 sends a request to print a receipt indicating transaction contents of products purchased in one transaction.

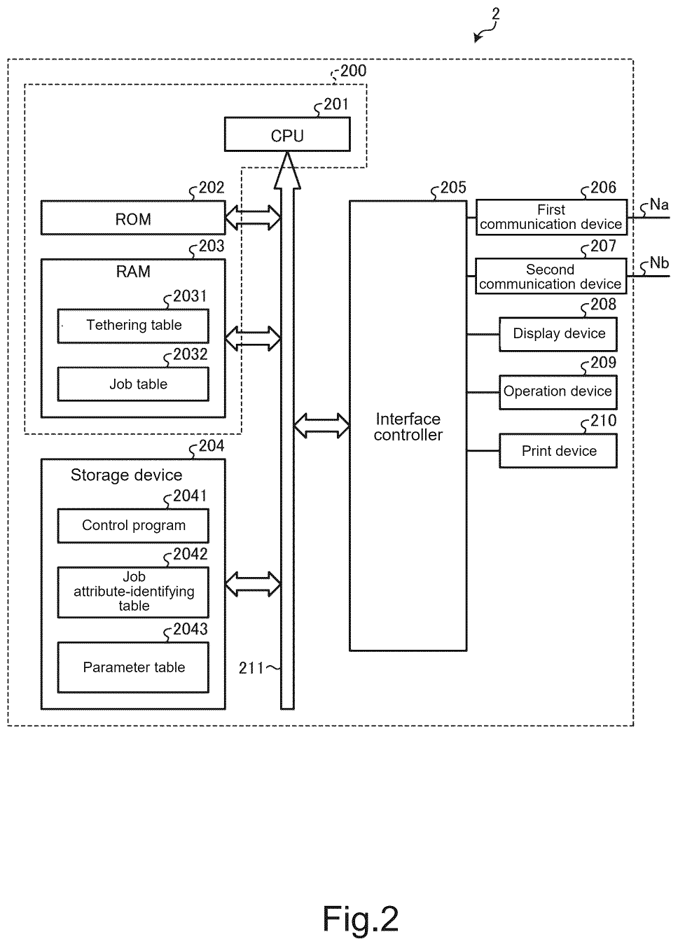

Next, a configuration of the above-mentioned printer 2 will be described with reference to FIG. 2. FIG. 2 is a block diagram showing an example of hardware configurations of the printer 2 according to the embodiment. As shown in FIG. 2, the printer 2 includes a central processing unit (CPU) 201 as an example of a processor, a read only memory (ROM) 202, a random access memory (RAM) 203, and a storage device 204.

Moreover, the controller 200 includes a time counting unit (not shown) such as a real time clock (RTC). The time counting unit has a time counting function of counting the current date and time, a timer function of counting an elapsed time, and other functions.

The CPU 201 comprehensively controls the respective units of the printer 2. The ROM 202 stores various programs. The RAM 203 is a workspace for deploying programs and various types of data. For example, the RAM 203 stores a tethering table 2031 and a job table 2032.

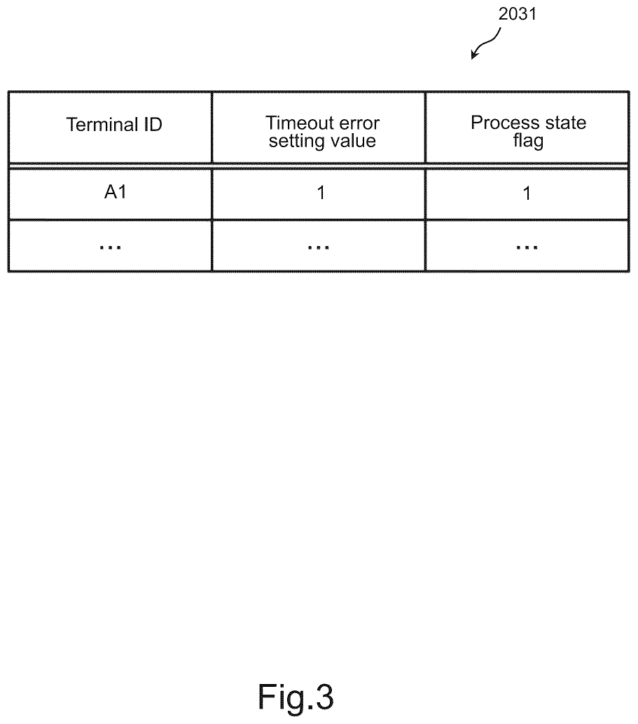

The tethering table 2031 is a data table or database that manages a tethering state. FIG. 3 is a diagram showing an example of data configurations of the tethering table 2031. As shown in FIG. 3, the tethering table 2031 stores a terminal ID, a timeout error setting value, and a process state flag.

The terminal ID is identification information for uniquely identifying the employee terminal 3. The timeout error setting value is an example of the parameter associated with the execution of the process. The timeout error setting value is a parameter associated with the timeout of the process. Details of the timeout error setting value will be described later.

The process state flag is flag information as to whether or not the tethering is running. The process state flag is flag information with a binary value which is for example “1” when the flag is valid (hereinafter, also referred to as on-state) and “0” when the flag is invalid (hereinafter, also referred to as off-state). Specifically, when the process state flag is in the on-state, the controller 200 of the printer 2 determines that the tethering with the employee terminal 3 corresponding to the terminal ID associated with the process state flag is running. Moreover, when the process state flag is in the off-state, the controller 200 of the printer 2 determines that the tethering with the employee terminal 3 corresponding to the terminal ID associated with the process state flag is not running.

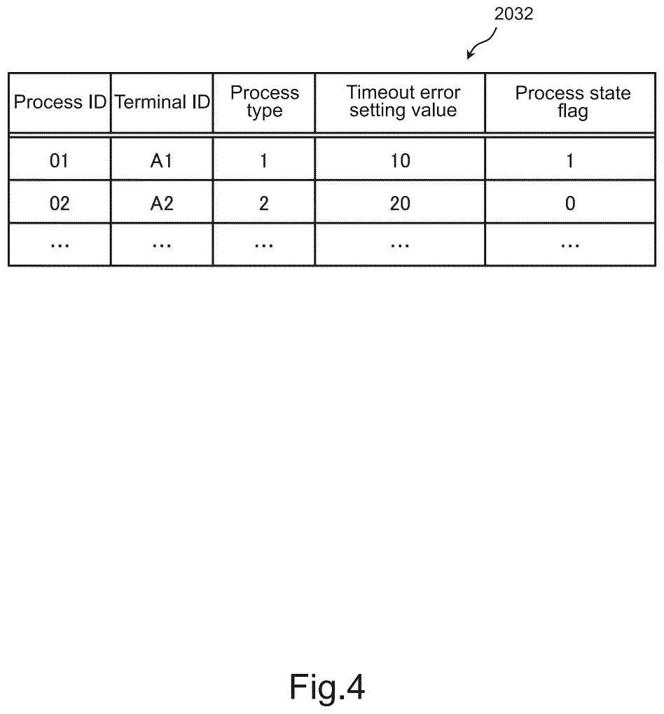

Referring back to FIG. 2, the job table 2032 is a data table or database for managing a request received by the printer 2. FIG. 4 is a diagram showing an example of data configurations of the job table 2032. As shown in FIG. 4, the job table 2032 stores a process ID, a terminal ID, a process type, a timeout error setting value, a process state flag, and the like.

The process ID is identification information for uniquely identifying requests received by the printer 2. Moreover, the terminal ID is identification information for uniquely identifying the employee terminal 3 and the POS terminal 4. Moreover, the process type is attribute information indicating attributes of the processes identified by a job attribute-identifying table 2042 to be described later.

The timeout error setting value is an example of the parameter associated with the execution of the process. The timeout error setting value is a parameter associated with the timeout of the process. Specifically, the timeout error setting value is a value defining an upper limit of an allowable running time when the CPU 201 executes a particular process. In other words, the controller 200 of the printer 2 determines that the process is in a timeout state when a particular execution processing time exceeds the timeout error setting value. The process state flag is flag information as to

whether or not the process associated with the process ID is running. The process state flag is flag information with a binary value which is for example “1” when the flag is valid (hereinafter, also referred to as on-state) and “0” when the flag is invalid (hereinafter, also referred to as off-state). Specifically, when the process state flag is in the on-state, the controller 200 of the printer 2 determines that the process with the process ID associated with the process state flag is running. Moreover, when the process state flag is in the off-state, the controller 200 of the printer 2 determines the process with the process ID associated with the process state flag is not running, i.e., in a process standby state.

The storage device 204 is a nonvolatile memory such as a hard disc drive (HDD) or a flash memory that retains stored information also after it is powered off. The storage device program 204 includes a control 2041, the job attribute-identifying table 2042, and a parameter table 2043.

The control program 2041 stores a control program for controlling the printer 2. The CPU 201, the ROM 202, the RAM 203, and the storage device 204 are connected to each other via a bus 211. The CPU 201, the ROM 202, and the RAM 203 constitute the controller 200 as a computer configuration. That is, the controller 200 performs control processing on the printer 2 to be described later by the CPU 201 operating in accordance with the control program 2041 stored in the ROM 202 or the storage device 204 and deployed in the RAM 203.

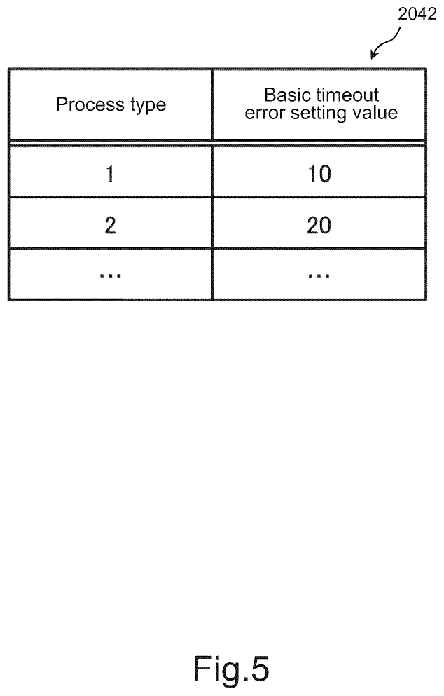

The job attribute-identifying table 2042 is a data table or database for identifying attributes of jobs received by the printer 2. FIG. 5 is a diagram showing an example of data configurations of the job attribute-identifying table 2042. As shown in FIG. 5, the job attribute-identifying table 2042 stores a process type, a basic timeout error setting value, and the like.

The process type is information indicating the type of process. The process type is numeric information indicating a numeric value representing the type for example which is assigned in advance per type of process executable by the printer 2. Here, the process executable by the printer 2 includes at least the above-mentioned tethering and print job. Moreover, the basic timeout error setting value is a timeout error setting value set by default when the printer 2 receives a request and it is assumed that one process type corresponds to one basic timeout error setting value. In other words, if processes are the same process type, their basic timeout error setting values are also the same.

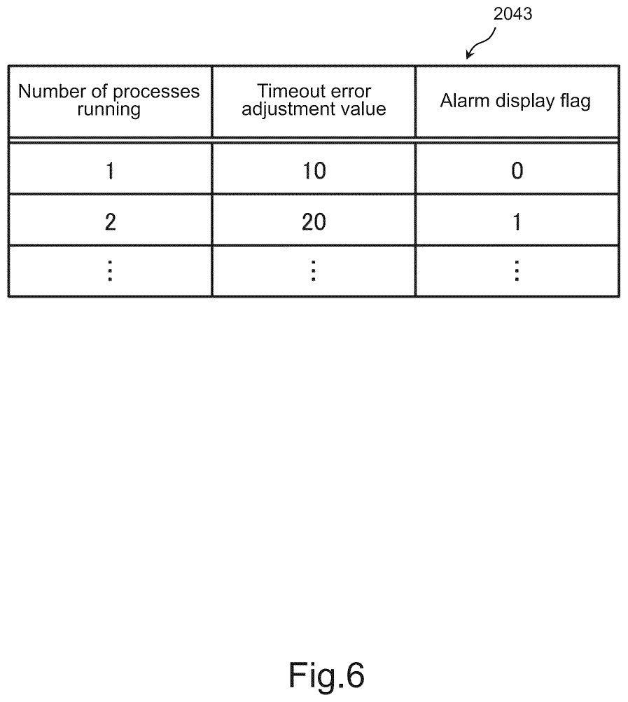

Referring back to FIG. 2, the parameter table 2043 is a data table or database storing the number of processes executed by the printer 2 in parallel and adjustment values or the like of the parameter associated with the execution of the processes in association with each other. FIG. 6 is a diagram showing an example of data configurations of the parameter table 2043. As shown in FIG. 6, the parameter table 2043 stores the number of running processes, timeout error adjustment values, display alarm flags, and the like.

The number of running processes is numeric information representing the number of processes executed by the printer 2. Specifically, the number of running processes means the number of pieces of data with the process state flag in the on-state in the tethering table 2031 and the job table 2032.

The timeout error adjustment value is a value for adjusting the above-mentioned timeout error setting value that is an example of the parameter. Specifically, the timeout error adjustment value is a value added to the basic timeout error setting value in accordance with the number of running processes. The display alarm flag is flag information as to whether or not the controller 200 of the printer 2 outputs to a display device 208 a notice (hereinafter, also referred to as timeout alarm notice) indicating that a timeout error is highly likely to occur in accordance with the number of running processes.

The display alarm flag is flag information with a binary value which is for example “1” when the flag is valid (hereinafter, also referred to as on-state) and “0” when the flag is invalid (hereinafter, also referred to as off-state). Specifically, when the display alarm flag is in the on-state, the controller 200 of the printer 2 determines that the timeout error is highly likely to occur and outputs the timeout alarm notice to the display device 208.

Referring back to FIG. 2, the controller 200 is connected to a first communication device 206, a second communication device 207, the display device 208, an operation device 209, and the print device 210 via an interface controller 205 and the bus 211.

The first communication device 206 is a communication interface for connecting to the employee terminal 3. Moreover, the second communication device 207 is a communication interface for connecting to the network Nb. Moreover, the second communication device 207 is connected to the network Nc via a communication device (not shown).

The interface controller 205 is connected to the first communication device 206, the second communication device 207, the display device 208, the operation device 209, and the print device 210. Then, the interface controller 205 controls the connected respective units on the basis of commands from the controller 200.

The display device 208 is a display device such as a liquid crystal display (LCD). Under the control of the CPU 201, the display device 208 displays various types of information associated with the state and operation of the printer 2. The operation device 209 is a touch panel provided in the display device 208, for example. The operation device 209 receives various operation instructions with respect to the printer 2. It should be noted that the operation device 209 may be an input device such as a keyboard or a pointing device. The print device 210 includes a print head, a sheet-conveying mechanism, and the like and performs printing (image formation) on a printing medium on the basis of an instruction of the controller 200. It should be noted that a printing method for the print device 210 is not particularly limited.

It should be noted that the display device 208 may have a display form as a control panel in which the display device 208 and the operation device 209 are integrated. Moreover, the display device 208 may have a display form as a display that displays various types of information of the printer 2 to the store employee or customer. Moreover, the display device 208 may have both the display forms.

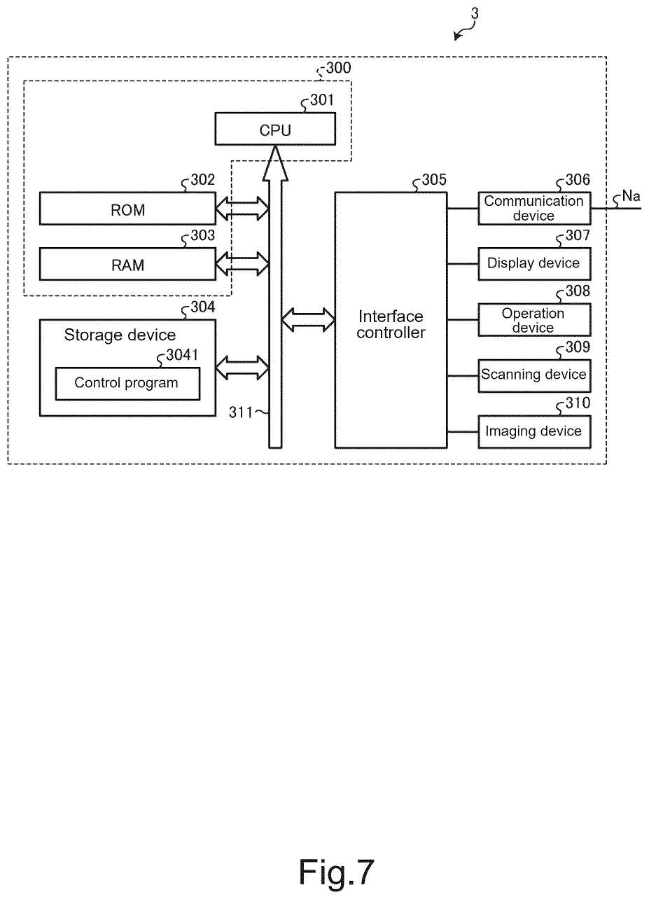

Next, a configuration of the above-mentioned employee terminal 3 will be described with reference to FIG. 7. FIG. 7 is a block diagram showing an example of hardware configurations of the employee terminal 3 according to the embodiment. As shown in FIG. 7, the employee terminal 3 includes a CPU 301 as an example of a processor, a ROM 302, a RAM 303, and a storage device 304.

The CPU 301 comprehensively controls the respective units of the employee terminal 3. The ROM 302 stores various programs. The RAM 303 is a workspace for deploying programs and various types of data.

The storage device 304 is a nonvolatile memory such as an HDD or a flash memory that retains stored information also after it is powered off. The storage device 304 includes a control program 3041.

The control program 3041 stores a control program for controlling the employee terminal 3. The CPU 301, the ROM 302, the RAM 303, and the storage device 304 are connected to each other via a bus 312. The CPU 301, the ROM 302, and the RAM 303 constitute a controller 300 as a computer configuration. That is, the controller 300 performs control processing on the employee terminal m to be described later by the CPU 301 operating in accordance with the control program 3041 which has been stored in the ROM 302 or the storage device 304 and deployed in the RAM 303.

The controller 300 is connected to a communication device 306, a display device 307, an operation device 308, a scan device 309, and an imaging device 310 via an interface controller 305 and the bus 312. Here, the communication device 306 is a communication interface for connecting to the printer 2 via the connection line Na.

The interface controller 305 is connected to the communication device 306, the display device 307, the operation device 308, the scan device 309, and the imaging device 310. Then, the interface controller 305 controls the connected respective units on the basis of commands from the controller 300.

The display device 307 is a display device such as an LCD. Under the control of the CPU 301, the display device 307 displays various types of information. The operation device 308 is a touch panel provided in the display device 307. The operation device 308 outputs to the CPU 301 operation contents input via the input device. It should be noted that the operation device 308 may be an input device such as a keyboard or a pointing device.

The scan device 309 scans member information registered in the customer's member card, for example. Moreover, the scan device 309 may scan for example registered information of a credit card or a charged amount of an electronic money card, a prepaid card, or the like that the customer uses for payment. The imaging device 310 is an imaging device such as a charge coupled device (CCD) or a complementary metal oxide semiconductor (CMOS).

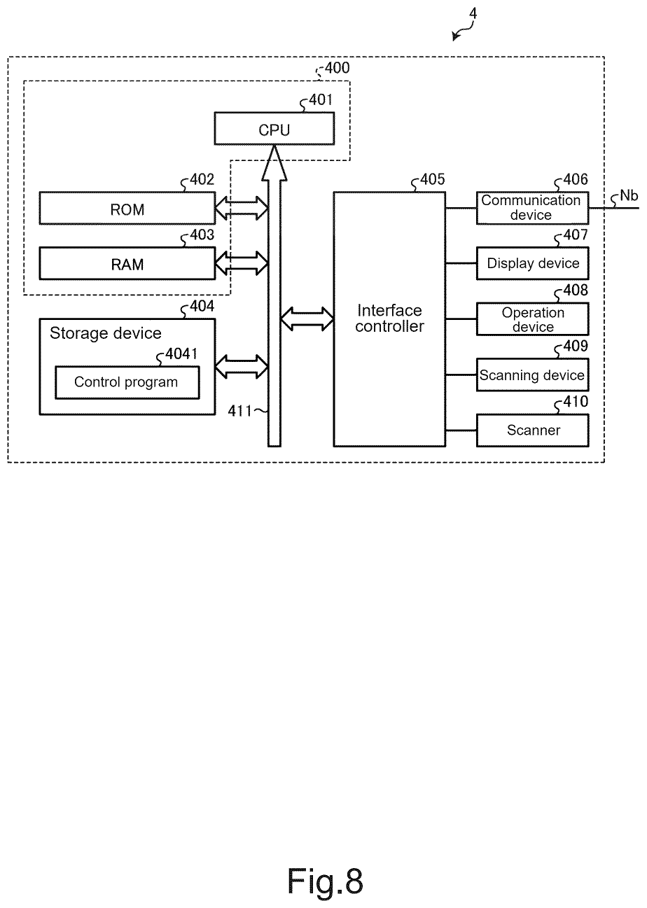

Next, a configuration of the above-mentioned POS terminal 4 will be described with reference to FIG. 8. FIG. 8 is a block diagram showing an example of hardware configurations of the POS terminal 4 according to the embodiment. As shown in FIG. 8, the POS terminal 4 includes a CPU 401 as an example of a processor, a ROM 402, a RAM 403, and a storage device 404.

The CPU 401 comprehensively controls the respective units of the POS terminal 4. The ROM 402 stores various programs. The RAM 403 is a workspace for deploying programs and various types of data.

The storage device 404 is a nonvolatile memory such as an HDD or a flash memory that retains stored information also after it is powered off. The storage device 404 includes a control program 4041.

The control program 4041 stores a control program for controlling the employee terminal 3. The CPU 401, the ROM 402, the RAM 403, and the storage device 404 are connected to each other via a bus 411. The CPU 401, the ROM 402, and the RAM 403 constitute a controller 400 as a computer configuration. That is, the controller 400 performs control processing on the POS terminal 4 to be described later by the CPU 401 operating in accordance with the control program 4041 which has been stored in the ROM 402 or the storage device 404 and deployed in the RAM 403.

The controller 400 is connected to a communication device 406, a display device 407, an operation device 408, a scan device 409, and a scanner 410 via an interface controller 405 and the bus 411. Here, the communication device 406 is a communication interface for connecting to the network Nb. Moreover, the communication device 406 is connected to the network Nc such as the Internet via the communication device (not shown).

The interface controller 405 is connected to the communication device 406, the display device 407, the operation device 408, the scan device 409, and the scanner 410. Then, the interface controller 405 controls the connected respective units on the basis of commands from the controller 400. The display device 407 is a display device such as an LCD. Under the control of the CPU 401, the display device 407 displays various types of information. The operation device 408 is a touch panel provided in the display device 407. The operation device 408 outputs to the CPU 401 operation contents input via the input device. It should be noted that the operation device 408 may be an input device such as a keyboard or a pointing device.

The scan device 409 scans member information registered in the customer's member card, for example. Moreover, the scan device 409 may scan for example registered information of a credit card or a charged amount of an electronic money card, a prepaid card, or the like that the customer uses for payment. The scanner 410 is a scan device capable of scanning a code symbol such as a barcode or two-dimensional code. The scanner 410 scans information retained in the code symbol by decoding the code symbol and outputs the scanned information to the CPU 401. For example, the scanner 410 scans a product code from the code symbol such as a barcode added to a product.

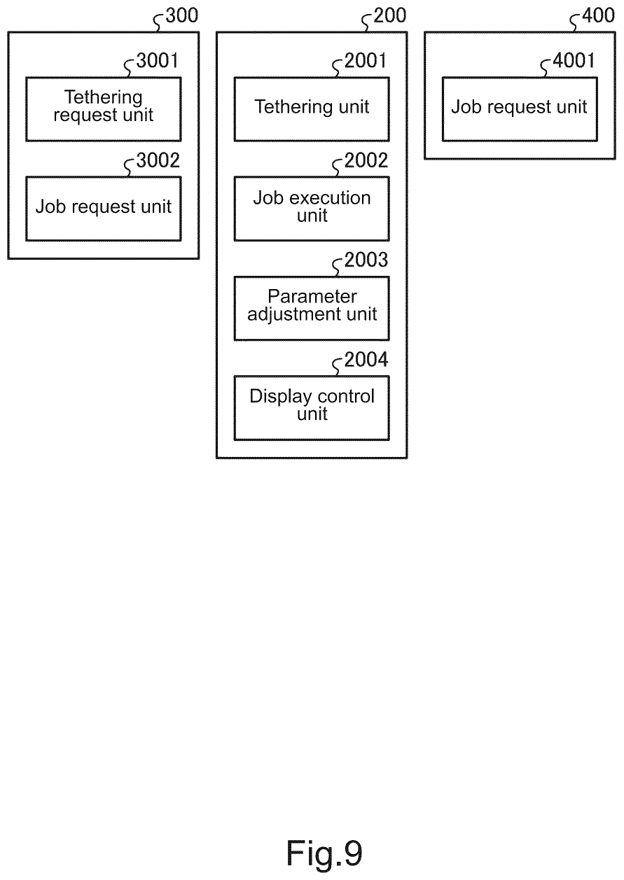

Next, function configurations of the respective control units of the printer 2, the employee terminal 3 and the POS terminal 4 will be described with reference to FIG. 9. FIG. 9 is a block diagram showing an example of the function configurations of the printer 2, the employee terminal 3, and the POS terminal 4 according to the embodiment. As shown in FIG. 9, the controller 200 of the printer 2 includes a tethering unit 2001, a job execution unit 2002, a parameter adjustment unit 2003, and a display control unit 2004 as function configurations. Moreover, the employee terminal 3 includes a tethering request unit 3001 and a job request unit 3002 as function configurations. Moreover, the POS terminal 4 includes a job request unit 4001 as function configurations. It should be noted that the function configurations provided in the printer 2, the employee terminal 3, and the POS terminal 4 are not limited thereto.

Specifically, the controller (CPU 201) of the printer 2 realizes the above-mentioned function configurations by executing the control program 2041 stored in the storage device 204. Moreover, the controller 300 (CPU 301) of the employee terminal 3 realizes the above-mentioned function configurations by executing the control program 3041 stored in the storage device 304. Moreover, the controller 400 (CPU 401) of the POS terminal 4 realizes the above-mentioned function configurations by executing the control program 4041 stored in the storage device 404. It should be noted that in the present embodiment, the above-mentioned function configurations are software configurations realized by cooperation of the processor and the program for each apparatus, though not limited thereto and some or all of the function configurations may be hardware configurations realized by dedicated circuits or the like.

First of all, function configurations of the printer 2 will be described. The tethering unit 2001 executes tethering that allows connection of the employee terminal 3 to the network Nc in accordance with a request from the employee terminal 3. Specifically, when the tethering unit 2001 receives the tethering request, the tethering unit 2001 refers to the tethering table 2031 and changes the process state flag corresponding to ID included in the tethering request into the on-state. Then, the tethering unit 2001 executes tethering by connecting the employee terminal 3 to the network Nc via the printer 2.

Moreover, the tethering unit 2001 makes a determination as to the timeout state of the running tethering on the basis of the timeout error setting value set to the tethering table 2031 by cooperating with the parameter adjustment unit 2003.

Moreover, when the tethering unit 2001 receives from the controller 200 a notice (hereinafter, also referred to as tethering end notice) indicating that the tethering ends, the tethering unit 2001 refers to the tethering table 2031 and changes the process state flag corresponding to the terminal ID included in the tethering end notice into the off-state. The tethering unit 2001 terminates the tethering according to the employee terminal 3 correspondingly.

The job execution unit 2002 is an example of a reception means and an execution means. The job execution unit 2002 receives an executable request from the employee terminal 3 or the POS terminal 4. Moreover, the job execution unit 2002 executes a process according to the received request. It should be noted that in a case where the job execution unit 2002 cannot immediately execute the process according to the received request, the job execution unit 2002 sets a process state flag of the request to be in the off-state and stores it in the job table 2032.

Moreover, the job execution unit 2002 determines whether or not the process for which the process state flag is in the off-state, i.e., an execution standby process is put in an executable state with respect to each process stored in the job table 2032. Then, in a case where there is a process in the executable state, the job execution unit 2002 sets the process as a target to be processed by changing the process state flag of the process into the on-state. Here, whether or not the process is in the executable state can be determined on the basis of the process type of the execution standby process, the state of the processing load of the printer 2, or the like.

For example, in a case of a print process, only one print process can be handled at a time, and therefore it can be determined that the execution standby print process can be put in an enabled state in a case where the previous print process ends or that there are no print processes running. Moreover, in a case where the processing load of the printer 2 is high, the execution standby may be continued even when the print process (or other process) is in the executable state and it may be determined that the print process is in the executable state under the condition that the processing load lowers. In this case, for example, a use rate of the CPU 201 of the printer 2 may be employed as an indication of the processing load and the print process may be executed when the use rate is equal to or lower than a preset threshold.

Moreover, the job execution unit 2002 makes a determination as to the timeout state with respect to the processes running on the basis of the timeout error setting value set to the job table 2032 by cooperating with the parameter adjustment unit 2003.

Moreover, when one of the running processes ends, the job execution unit 2002 deletes a data entry associated with the process ID of this process from the job table 2032.

The parameter adjustment unit 2003 is an example of an adjustment means. The parameter adjustment unit 2003 sets and adjusts (changes) a predetermined parameter associated with the requested various processes by cooperating with the tethering unit 2001 and the job execution unit 2002.

Specifically, when the tethering unit 2001 or the job execution unit 2002 receives a request, the parameter adjustment unit 2003 refers to the job attribute-identifying table 2042 and obtains a basic timeout error setting value corresponding to a process according to the type of request received. Then, the parameter adjustment unit 2003 refers to the job table 2032 and the process state flag obtains the number of processes in the on-state, i.e., the number of running processes. Then, the parameter adjustment unit 2003 determines whether or not the obtained number of running processes is one.

In a case where the number of running processes is one, the parameter adjustment unit 2003 stores the obtained basic timeout error setting value as a timeout error setting value in the management table (tethering table 2031, job table 2032) according to the received request.

Moreover, in a case where the number of running processes is two or more, the parameter adjustment unit 2003 obtains from the parameter table 2043 a timeout error adjustment value corresponding to the number of processes. Then, the parameter adjustment unit 2003 sets a value obtained by adding the timeout error adjustment value to the basic timeout error setting value as a timeout error setting value and stores it in the management table (tethering table 2031, job table 2032) according to the received request.

It should be noted that the parameter adjustment unit 2003 may obtain the number of running processes when any process ends or every time a new process is executed and adjust the timeout error setting values of the processes running in accordance with the obtained number of processes.

The display control unit 2004 is an example of an output means. The display control unit 2004 outputs a timeout alarm notice indicating that the execution of the processes may take a long time. Specifically, the display control unit 2004 causes the display device 208 to display the timeout alarm notice in a case where the display alarm flag corresponding to the number of running processes is in the on-state by cooperating with the parameter adjustment unit 2003.

Subsequently, function configurations of the employee terminal 3 will be described. The tethering request unit 3001 sends a tethering request to the printer 2. Specifically, the tethering request unit 3001 sends a tethering request including the terminal ID of the employee terminal 3 to the printer 2 in response to an operation of the operation device 308 of the employee terminal 3 from the operator.

The job request unit 3002 sends a job request to the printer 2. Specifically, the job request unit 3002 sends a job request including the terminal ID to the printer 2 in response to an operation of the operation device 308 of the employee terminal 3 from the operator.

Subsequently, function configurations of the POS terminal 4 will be described. The job request unit 4001 sends a job request to the printer 2. Specifically, the job request unit 4001 sends a job request including the terminal ID of the POS terminal 4 to the printer 2 in response to an operation of the operation device 408 of the POS terminal 4 from the operator. Here, the job request refers to for example a process request to print a receipt associated with a settlement process of the POS terminal 4.

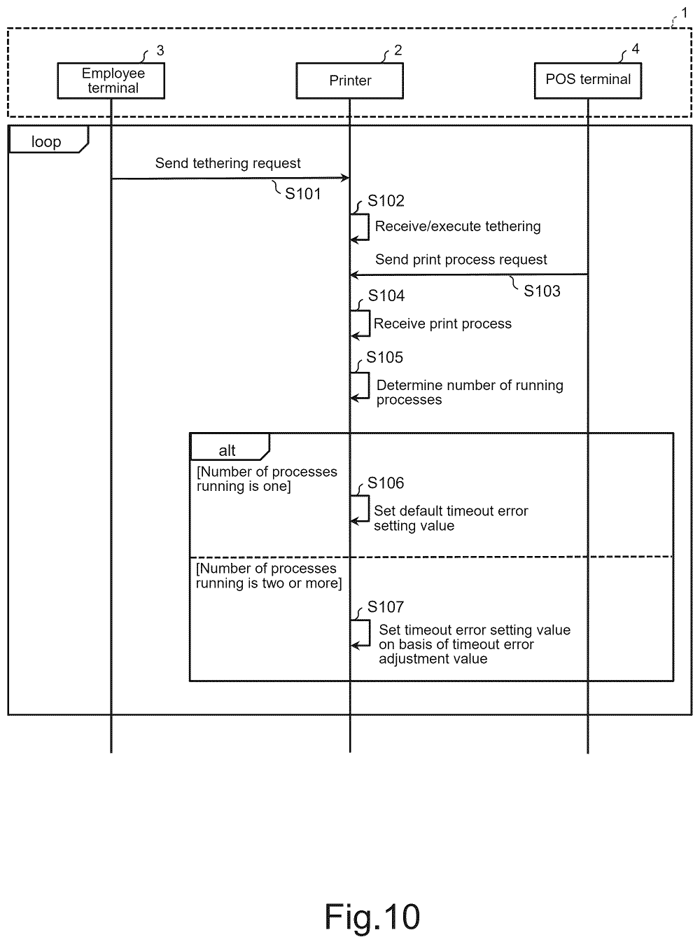

Next, control processing of the printer system 1 will be described with reference to FIG. 10. FIG. 10 is a sequence diagram showing an example of the control processing of the printer system 1 according to the embodiment. A sequence diagram shown in FIG. 10 shows a processing example in a case where the printer 2 receives a tethering request from the employee terminal 3, and then the printer 2 receives a print process request from the POS terminal 4 and sets a timeout error setting value in accordance with the number of running processes in the printer 2.

First of all, the tethering request unit 3001 of the employee terminal 3 sends a tethering request including the terminal ID of the employee terminal 3 to the printer 2 in response to an operation of the operation device 308 of the employee terminal 3 from the operator (Step S101). When the tethering unit 2001 of the printer 2 receives the tethering request, the tethering unit 2001 of the printer 2 refers to the tethering table 2031 and changes the process state flag corresponding to the terminal ID included in the tethering request into the on-state (Step S102).

It should be noted that the process in the on-state in the phase of Step S102 is only tethering. In this case, the parameter adjustment unit 2003 obtains a basic timeout error setting value corresponding to the tethering as a process type from the job attribute-identifying table 2042 and stores it in the tethering table 2031 as a timeout error setting value. The tethering table 2031 executes the requested tethering on the basis of the timeout error setting value set by the parameter adjustment unit 2003.

Subsequently, the job request unit 4001 of the POS terminal 4 sends a print job request including the terminal ID of the POS terminal 4 to the printer 2 in response to an operation of the operation device 408 of the POS terminal 4 from the operator (Step S103). When the job execution unit 2002 of the printer 2 receives the print job request (Step S104), the job execution unit 2002 of the printer 2 registers a data entry according to the request in the job attribute-identifying table 2042 and sets the process state flag to be in the on-state.

The process in the on-state is tethering and print job in the phase of Step S104. The parameter adjustment unit 2003 obtains the number of processes in the on-state, i.e., the number of running processes and determines whether the obtained number of processes is one or not (or two or more) (Step S105).

In a case where the number of running processes is one, the parameter adjustment unit 2003 sets the basic timeout error setting value obtained from the job attribute-identifying table 2042 as a timeout error setting value and stores it in the job table 2032 in association with the corresponding print job (Step S106).

Moreover, in a case where the number of running processes is two or more, the parameter adjustment unit 2003 refers to the parameter table 2043 and obtains a timeout error adjustment value corresponding to the number of running processes obtained by the job execution unit 2002. Then, the parameter adjustment unit 2003 sets a value obtained by adding the timeout error adjustment value to the basic timeout error setting value obtained from the job attribute-identifying table 2042 as a timeout error setting value and stores it in the job table 2032 in association with the corresponding print job (Step S107).

As described above, with the printer system 1, it is possible to receive and execute the tethering request from the employee terminal 3 in accordance with the above-mentioned processing. Moreover, with the printer system 1, it is possible to receive and execute the job request from the POS terminal 4. Moreover, with the printer system 1, the occurrence of the timeout error can be suppressed by changing the parameter associated with the execution of the processes in accordance with the number of running processes.

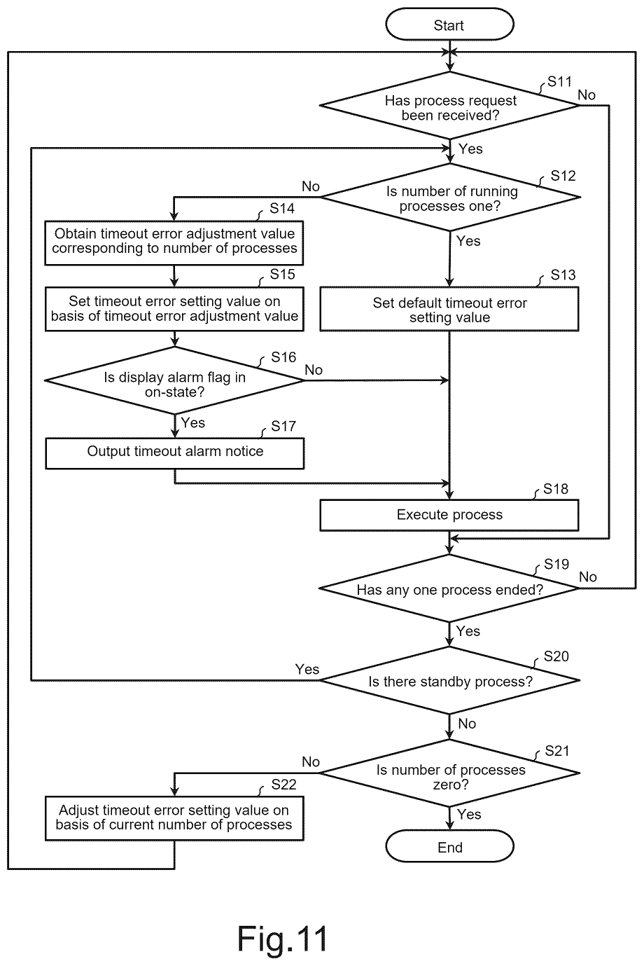

Next, control processing of the controller 200 of the printer 2 will be described with reference to FIG. 11. FIG. 11 is a flowchart showing an example of a flow of processing performed by the controller 200 of the printer 2 according to the embodiment. The flowchart shown in FIG. 1 shows processing example in a case of changing the parameter associated with the execution of the processes.

First of all, the tethering unit 2001 or the job execution unit 2002 determines whether or not the tethering unit 2001 or the job execution unit 2002 has received a request (process request) (Step S11). Here, in a case where the tethering unit 2001 or the job execution unit 2002 has received no requests (No in Step S11), the processing shifts to Step S19.

In a case where the tethering unit 2001 or the job execution unit 2002 has received a request in Step S11 (Yes in Step S11), the parameter adjustment unit 2003 refers to the tethering table 2031 and the job table 2032 and obtains the number of processes with the process state flag in the on-state, i.e., the number of running processes. Then, the parameter adjustment unit 2003 determines whether or not the number of running processes is one (Step S12).

In a case where the number of running processes is one (Yes in Step S12), the parameter adjustment unit 2003 obtains a basic timeout error setting value corresponding to the process type of the running process from the job attribute-identifying table 2042. Then, the parameter adjustment unit 2003 sets the obtained basic timeout error setting value as a timeout error setting value in the job table 2032 in association with the data entry of the running process (Step S13) and shifts to Step S18.

On the other hand, in a case where the number of running processes is two or more (No in Step S12), the parameter adjustment unit 2003 refers to the parameter table 2043 and obtains a timeout error adjustment value corresponding to the number of running processes (Step S14). Moreover, the parameter adjustment unit 2003 refers to the job table 2032 and calculates an adjusted timeout error setting value for each process by adding the obtained timeout error adjustment value to the basic timeout error setting value of each running process. Then, the parameter adjustment unit 2003 sets the calculated timeout error setting value in the job table 2032 in association with the data entry of the corresponding processes (Step S15).

Subsequently, the display control unit 2004 determines whether or not the display alarm flag corresponding to the number of running processes is the on-state by cooperating with the parameter adjustment unit 2003 (Step S16). Here, in a case where the display alarm flag is the on-state (Yes in Step S16), the display control unit 2004 causes the display device 208 to display a timeout alarm notice (Step S17) and shifts to Step S18. Moreover, in a case where the display alarm flag is in the off-state (No in Step S16), the processing shifts to Step S18.

In next Step S18, the tethering unit 2001 or the job execution unit 2002 executes the requested process on the basis of the timeout error setting value set in Step S13 or Step S15 (Step S18). Moreover, in a case where the timeout error setting value is updated also with respect to the already running process, the tethering unit 2001 or the job execution unit 2002 continues the process on the basis of the updated timeout error setting value.

Subsequently, the tethering unit 2001 or the job execution unit 2002 determines whether or not any one running process has ended (Step S19). In a case where the tethering unit 2001 or the job execution unit 2002 determines that any process has not ended (No in Step S19), and the processing returns to Step S11. Moreover, in a case where the tethering unit 2001 or the job execution unit 2002 determines that any one process has ended (Yes in Step $19), the job execution unit 2002 determines whether or not there is a process in the process standby state and the process is in the executable state (Step S20). It should be noted that since in the present embodiment, the process in the process standby state is generated as a process handled by the job execution unit 2002, the tethering unit 2001 may skip Step S20.

In a case where there is a process in the process standby state and the process is in the executable state (Yes in Step S20), the job execution unit 2002 puts the process state flag associated with this process in the on-state and then the processing returns to Step S12. Accordingly, the process in the process standby state is handled as a new running process.

Moreover, in a case where there are no processes in the process standby state in Step S20 or in a case where no processes are in the executable state (No in Step S20), the parameter adjustment unit 2003 determines whether or not the current number of processes is zero (Step S21). Here, in a case where the number of processes is not zero, the parameter adjustment unit 2003 adjusts the timeout error setting value on the basis of the current number of processes (Step S22) and the processing returns to Step S11. Moreover, in a case where the number of running processes is zero (Yes in Step S21), this processing is terminated.

As described above, in the printer system 1 according to the present embodiment, the printer 2 receives the tethering request from the employee terminal 3 and executes the tethering. Moreover, the printer 2 receives the job request from the POS terminal 4 and executes the job. Then, the printer 2 changes the parameter associated with the execution of the processes in accordance with the number of running processes. Moreover, the printer 2 causes the display device 208 of the printer 2 to display the timeout alarm notice in accordance with the number of running jobs.

Accordingly, in the printer system 1 according to the present embodiment, the parameter associated with the execution of the processes can be changed in a case where the processing load on the CPU 201 of the printer 2 is estimated to be heavy due to a large number of processes running in parallel. Therefore, in the printer system 1 according to the present embodiment, it is possible to avoid suspension and the like of the processes due to timeout and process the processes requested by the process requests in parallel by dynamically changing the allowable running time of the process requested by the process request with respect to the process to run requested by each process request.

It should be noted that the above-mentioned embodiment can also be modified and carried out as appropriate by modifying some of the configurations or functions of each device described above. In this regard, some modified examples of the above-mentioned embodiment will be described as other embodiments hereinafter. It should be noted that following description, different points from the above-mentioned embodiment will be mainly described and detailed descriptions of points common to the above contents will be omitted. In addition, the modified examples described below may be carried out individually or may be carried out in combination as appropriate.

### Modified Example 1

In the above-mentioned embodiment, the display control unit 2004 causes the display device 208 to display the timeout alarm notice in Step S17, though not limited thereto. The display control unit 2004 may send the timeout alarm notice to the external device connected to the printer 2 via the connection line Na or the network Nb so as to cause a display unit of the external device to display the timeout alarm notice.

### Modified Example 2

A notice for checking whether or not a timeout error has occurred may be sent from the POS terminal 4 to the printer 2 for checking the occurrence of the timeout error.

### Modified Example 3

In the above-mentioned embodiment, the same timeout error adjustment value is added in accordance with the number of running processes in the parameter table 2043, though not limited thereto. For example, timeout error adjustment values according to the number of processes per process type may be prestored in the parameter table 2043 or the like, such that a timeout error setting value can be derived from the timeout error adjustment values according to the number of running processes and the process type.

It should be noted that the program executed by the printer system 1 according to the embodiment and the modified examples may be configured to be stored in a computer connected to the network such as the Internet and be provided by being downloaded via the network. Moreover, the program executed by the printer system 1 according to the embodiment and the modified examples may be configured to be provided or delivered via the network such as the Internet.

It should be noted that the program executed by each device according to the above-mentioned embodiment is provided in a state incorporated in the ROM, the storage unit, or the like in advance. The program executed by each device according to the above-mentioned embodiment may be configured to be provided, recorded on a computer-scannable recording medium such as a CD-ROM, a flexible disk (FD), a CD-R, or a digital versatile disk (DVD) with a file in an installable or executable format.

In addition, the program executed by each device according to the above-mentioned embodiment may be configured to be stored in a computer connected to the network such as the Internet and be provided by being downloaded via the network. Moreover, the program executed by each device according to the above-mentioned embodiment may be configured to be provided or delivered via the network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A printer, comprising:
a storage device that stores a value related to setting of a predetermined parameter associated with execution of processes;
a communication device that is connected to be capable of communicating with an external device, the communication device communicating with the external device for the communication device to receive a process request of a process; and
a controller configured to
receive the process request from the external device via the communication device,
execute the requested process, and
refer to, in a case where the number of processes requested by the process request and executed is two or more, a value related to setting of the parameter stored in the storage device and adjust the parameter associated with the execution of the processes.

2. The printer according to claim 1, wherein
the predetermined parameter includes a parameter associated with timeout of the process requested by the process request.

3. The printer according to claim 1, wherein
the external device includes a first external device that is connected to the communication device on a first connection mode and a second external device that is connected to the communication device on a second connection mode different from the first connection mode, and
the controller receives process requests from the first external device and the second external device.

4. The printer according to claim 3, wherein
the first connection mode is a connection mode on which the first external device and the communication device are directly connected to each other.

5. The printer according to claim 1, further comprising
a display device, wherein
in a case where two or more processes requested by the process request are running, the controller outputs to the display device a notice indicating that there is a possibility that it takes a long time for executing the processes requested by the process requests.

6. The printer according to claim 1, wherein
the storage device has a job attribute table, and
the job attribute table stores a basic setting value of the parameter in accordance with a type of the process, and
the controller
obtains the basic setting value of the parameter from the job attribute table, and
adjusts, in a case where the number of processes requested by the process request and executed is two or more, the parameter associated with the execution of the processes on the basis of the obtained basic setting value of the parameter and sets the adjusted parameter as a parameter setting value.

7. The printer according to claim 6, wherein
the storage device further has a parameter table,
the parameter table stores an adjustment value of the parameter in accordance with the number of running processes, and
the controller
obtains, in a case where the number of processes requested by the process request and executed is two or more, an adjustment value of the parameter from the parameter table, and
adjusts the parameter associated with the execution of the processes by adding the obtained adjustment value of the parameter to the obtained basic setting value of the parameter.

8. The printer according to claim 6, wherein
the controller sets, in a case where the number of processes requested by the process request and executed is one, the obtained basic setting value of the parameter as a parameter setting value.

9. The printer according to claim 3, wherein
the communication device includes a first communication device that is connected to the first external device via a connection line as the first connection mode and a second communication device that is connected to the second external device via a network as the second connection mode.

10. A control method for a printer, comprising:
storing, by a storage device, a value related to setting of a predetermined parameter associated with execution of processes;
connecting to an external device via a communication device to be capable of communicating with the external device;
receiving a process request from the external device via the communication device;
executing the process requested by the process request; and
referring, in a case of executing the two or more processes by the process request, to a value related to setting of a parameter stored in a storage device and adjusting the parameter associated with the execution of the processes.
